(19) United States
(12) Patent Application Publication
(10) Pub. No.: US 2014/0055338 A1
(43) Pub. Date: Feb. 27, 2014

(54) GLOVE-BASED USER INTERFACE DEVICE

(71) Applicant: Edward P. Ryan, Woodside, NY (US)

(72) Inventor: Edward P. Ryan, Woodside, NY (US)

(21) Appl. No.: 13/592,266

(22) Filed: Aug. 22, 2012

(51) Int. Cl. G09G 5/00

(52) U.S. Cl. 345/156

(57) ABSTRACT

Interface devices and methods of use include a flexible frame configured to be worn by a user; one or more sensor wire bundles, each including a plurality of sensor wires connected at one end to a control module. The control module is configured to measure electrical changes in the sensor wire bundles and further configured to indicate a direction and speed of motion of a part of the user's body past the one or more sensor wire bundles based on the measured electrical changes in the sensor wire bundles.

### BACKGROUND

User interface devices, such as the computer mouse and keyboard, are commonly used with computing devices to allow a user to interact with the device and provide input. However, while such devices have proven to be very effective with standard devices such as desktop and laptop computers, their usefulness is limited with handheld and wearable devices.

One example of a wearable device without an easy to use interface device can be found in the Google® Glass project, which uses a head-mounted display in the form of a screen that is incorporated in a frame worn like a pair of glasses. The screen occupies a space above the user's standard field of vision, such that it does not interfere with the user's movements and perception, allowing the user to view information while going about daily tasks. However, the device is limited in the amount of control a user has. Without a separate input device, the user is forced to physically interact with hardware buttons on the display itself, which may be inconvenient if the user is occupied or wishes to remain discreet. Furthermore, the amount of input that is possible is strictly limited by the physical size of the display, which must be kept small and light to prevent interference with the user's activities.

Existing glove interface devices have been unsuccessful due to cumbersome and unintuitive design. Attempting to replicate a full suite of interface options results in an inferior user experience.

### SUMMARY

An interface device includes a flexible frame configured to be worn by a user; and one or more sensor wire bundles arranged in parallel on the frame, each comprising a plurality of sensor wires connected at one end to a control module, wherein the control module is configured to measure electrical changes in the sensor wire bundles and further configured to indicate a direction and speed of motion of a part of the user's body past the one or more sensor wire bundles based on the measured electrical changes in the sensor wire bundles.

An interface device includes a glove to be worn on a user's hand; one or more finger sensors, each running along a finger of the glove and each comprising a plurality of sensor wires connected at one end to a control module; and one or more finger terminals, each located at a fingertip of the glove, connected to the control module. The control module is configured to measure electrical changes in the sensor wire bundles, to indicate a direction and speed of motion of the user's thumb past the one or more finger sensors based on the measured electrical changes in the finger sensors, to measure electrical changes in the finger terminals, and to indicate a function activation based on a proximity of the user's thumb to a finger terminal based on the measured electrical changes in the finger terminal.

A method for measuring motion includes measuring an electrical change in one or more finger sensors in a glove-based interface device triggered by a motion of a user's thumb past the one or more finger sensors; determining an order and speed of electrical changes between indexed sensor wires in the one or more finger sensors; and indicating a direction and speed of motion of the user's thumb based on the order and speed of electrical changes using a processor.

These and other features and advantages will become apparent from the following detailed description of illustrative embodiments thereof, which is to be read in connection with the accompanying drawings.

### DESCRIPTION OF THE DRAWINGS

The disclosure will provide details in the following description of preferred embodiments with reference to the following figures wherein:

FIG. 1 is a diagram of a glove-based interface device according to the present principles;

FIG. 2 is a diagram of a control module for an interface device according to the present principles; and

FIG. 3 is a block/flow diagram if a method for measuring movement according to the present principles.

### DETAILED DESCRIPTION

User interfaces have changed substantially since the advent of the smartphone. Already, interfaces have been streamlined to limit the amount of text input needed, due to limitations inherent in smartphone design, reducing most interface actions to “navigation” and “clicking,” with “navigation” being further limited in most cases to unidirectional scrolling. As a result, a user interface device which replicates these functions will suffice in most use cases for a user's mobile computing interactions with a wearable display. Providing scrolling and a small set of interaction functions allows a user to dispense with a more complicated and unwieldy device, such as a keyboard and mouse.

The present principles provide an interface that may be incorporated with, e.g., a glove or other hand-worn frame to provide scrolling and interaction functions in an intuitive and unobtrusive manner. Using a limited set of sensing wires, a scrolling direction and speed may be generated by the simple gesture of passing one's thumb past one's fingers. This gesture is very intuitive and comfortable, allowing a user to maneuver in user interfaces, such as those described above, with ease.

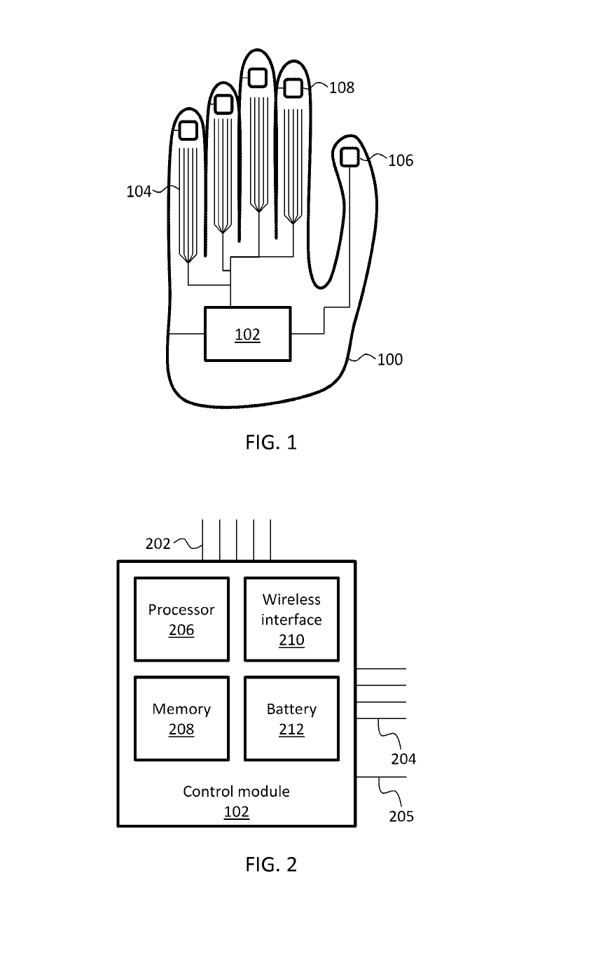

Referring now to FIG. 1, a diagram of a glove-based user interface 100 is shown. Although a glove is described and depicted throughout this disclosure, it is recognized that the present principles may be applied to other garments and/or interface devices. In particular, it should be recognized that the present principles need not be actuated specifically by finger or thumb motion, but may be adapted to be used with any motion of a user with respect to a surface.

A control module 102 is located on either the palm-side or the back side of the device 100. Although it is specifically contemplated that locating the control module 102 on the back or the cuff of the glove 100 will allow for greater user mobility and device durability, the present figures show the module 102 as being located at the palm for ease of illustration. It should further be recognized that the control module 102 may be formed from flexible or textile-based electronics, allowing for greater durability and comfort. The control module 102 is electrically connected to a set of finger sensors 104, each finger sensor 104 being formed from a set of wires. The glove 100 may be formed from any standard textile and may include a shielding layer between the finger sensors 104 and the user's hand. This shielding layer prevents the user's hand from triggering the finger sensors 104 unintentionally.

The wires that form finger sensors 104 are flexible, strong, and conductive. It is specifically contemplated that a braided metal wire may be used toward this end, to allow a user unimpeded finger mobility without sacrificing durability, but any suitably strong and flexible wire configuration, such as conductive plastic or silicone, may be employed. In an alternative embodiment, a ribbon cable may be used. The finger sensors 104 register changes in an electrical quantity, such as capacitance, as the user's thumb passes over them, and the control module 102 measures the changes in the electrical quantity to determine a direction and speed of movement.

Alternatively, a thumb terminal 106 is formed from, e.g., a metal plate and is electrically connected to control module 102 by a similar wire. The thumb terminal 106 may be charged with a low voltage. As the position of the charged thumb terminal 106 changes in proximity to the finger sensors 104, current flows in the finger sensors 104. Using a charged thumb terminal 106 can help prevent accidental triggers that may result from sensing capacitance changes alone. The thumb terminal 106 may be coated in an insulating layer to prevent electrical discharge and premature depletion of battery power.

In another alternative embodiment, the sensor wires of finger sensors 104 may be formed as loops, connected at both ends to the control module 102. The thumb terminal 106 may incorporate a magnet, such that the thumb terminal 106 induces currents in the finger sensors 104 as it passes by. The control module 102 may detect these current changes as above. A magnetic thumb terminal 106 removes the need for a voltage and need not be connected to the control module 102 at all.

Finger terminals 108 may be disposed on the fingertips of the glove 100. To inhibit interference between the finger terminals 108 and the finger sensors 104, the wire connecting the finger terminals 108 to control module 102 may travel along the opposite side of the finger, such that the thumb's motion across finger terminals 104 does not accidentally trigger the finger terminals 108. When the user taps a finger terminal 108 with the thumb or thumb terminal 106, the control module 102 detects the electrical change.

This embodiment provides the user with unidirectional scrolling as well as up to four functions (e.g, clicking). The specific functions performed at the tap of each finger terminal 108 may be designated by the user and may include, e.g., switching scroll orientation, clicking, initiating or ending a drag action, right-clicking, performing a “back” or “forward” operation in a web browser, copy, paste, undo, etc. If an interface with bidirectional scrolling is used, one function may change the scroll direction.

The use of thumb terminal 106 is optional and may depend on the thickness of the glove 100. If the glove is thin enough to allow the user's thumb to directly cause a measurable capacitance change, then no thumb terminal 106 is needed. However, the sensitivity of capacitative sensing may quickly attenuate with distance. As such, a thicker glove 100 will need a thumb terminal 106 to provide consistently discernible signals.

It should be understood that the elements shown in the figures may be implemented in various forms of hardware, software or combinations thereof. Preferably, these elements are implemented in software on one or more appropriately programmed general-purpose digital computers having a processor and memory and input/output interfaces.

As will be appreciated by those skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

Referring now to FIG. 2, a diagram of the control module 102 is shown. The control module 102 receives as inputs 202 wires from finger sensors 104. It should be noted that each individual wire from the finger sensors 104 may lead to a separate input 202. However, to reduce the complexity and to reduce the number of potential points of failure, the wires may be merged. Because only speed and direction are measured, absolute position of the thumb across the fingers need not be measured. Thus if, for example, each finger sensor 104 comprises five wires, the first wire of each finger sensor 104 may be merged, the second wire of each finger sensor 104 may be merged, and so on, before said wires reach control module 102. In this manner, the number of inputs 202 from the finger sensors 104 is reduced to, e.g., five.

The control module 102 finds a capacitance of each of the inputs 202 by, e.g., measuring how the capacitances affect the frequency of an oscillator such as an LC circuit. As the thumb moves past the finger sensors 104, the measured capacitances will change. This change is monitored by processor 206 and, in conjunction with the changes of the other inputs 202, is converted into a motion direction and speed.

An optional wire 205 may lead to a thumb terminal 106, providing a voltage to charge the thumb terminal 106. In the presence of a charged thumb terminal 106, sensing may be performed by measuring currents within the finger sensors 104. As the thumb terminal 106 approaches a wire in a finger sensor 104, current will flow in one direction responsive to the approaching charge. As the thumb terminal 106 recedes from the finger sensor 104, the current will reverse direction.

The control module 102 further receives as inputs 204 wires from each of the finger terminals 108. The capacitance or current of each of the inputs 204 is measured as above and monitored by processor 206. When the capacitance or current of a finger terminal 108 changes significantly, the processor 206 registers an activation of the associated function.

A wireless interface 210 communicates the determinations of the processor 206 to a user device such as, e.g., a smartphone, head-mounted device, or personal computer. The wireless interface 210 may communicate with any appropriate protocol, but it is specifically contemplated that the wireless interface 210 communicates using a Bluetooth interface and, in particular, the Bluetooth low energy feature of the Bluetooth 4.0 specification. It should be noted that wireline communication is also possible. However, tethering the device 100 with a wire will interfere with its ergonomics and utility. The wireless interface 210 is powered by, e.g., a battery 212 such as a coin or button cell battery. The outputs of the processor 206 may be stored temporarily in, e.g., an internal memory 208, before being transmitted. Additionally, calibration information may be stored in the memory 208.

It should be noted that the control module 102 may be configured to employ hysteresis or a threshold in its motion detection, stored as calibration information in memory 208. For example, to prevent unintentional triggering of finger sensors 104 or finger terminals 108, a threshold representing a minimum capacitance or current change may be used to determine whether the motion is unintentional or not. Changes that fall below the threshold are determined to be transient or unintentional and therefore are not sent over the wireless interface 210. This conserves power and prevents undesired triggering of user interface elements. In addition, gaps in a motion signal will occur as the user returns the thumb at the end of a swipe across finger sensors 104. As such, during fast scrolling, the control module 102 may continue to generate a motion indication after the signal has stopped, allowing the thumb time to return. This continued indication time may be calibrated for the individual user and may be associated with a reduced or decreasing motion speed.

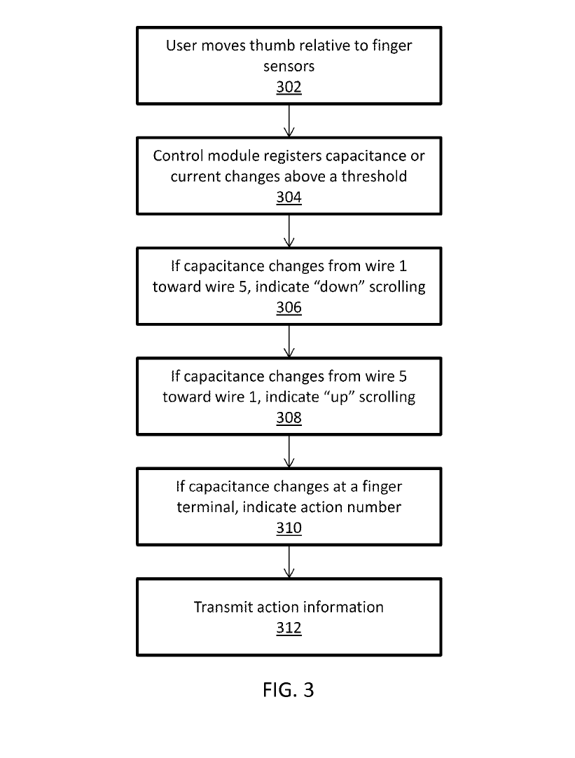

Referring now to FIG. 3, a block/flow diagram of a method of registering user inputs is shown. At block 302, the user moves their thumb relative to finger sensors 104 or finger terminals 108. As noted above, this creates capacitative or current changes that are detected by control module 102 at block 304. The changes are processed at the control module 102 to generate function trigger and motion information. In particular, the control module 102 determines whether the change exceeds a minimum threshold.

The inputs 202 may be indexed, e.g., 1-5. If a detected electrical change travels from wire 1 to wire 5 (wrapping around to wire 1 as the thumb returns or passes to another finger sensor), then block 306 determines that the user is moving the thumb in a given direction, defined here to be “down,” though those having skill in the art will recognize that such definition is arbitrary and could just as easily be assigned to “up.” If the detected capacitance change travels from wire 5 to wire 1 (wrapping around to wire 5), then block 308 determines that the user is moving the thumb in the opposite direction, defined here to be “up.” If instead the capacitance changes at a finger terminal 108, then an index associated with that finger terminal 108 is provided to trigger an associated action at block 310. The wireless interface 210 then transmits the determined action information at block 312.

Having described preferred embodiments for a glove-based user interface device (which are intended to be illustrative and not limiting), it is noted that modifications and variations can be made by persons skilled in the art in light of the above teachings. It is therefore to be understood that changes may be made in the particular embodiments disclosed which are within the scope of the invention as outlined by the appended claims. Having thus described aspects of the invention, with the details and particularity required by the patent laws, what is claimed and desired to be protected by Letters Patent is set forth in the appended claims.

1. An interface device, comprising:
a flexible frame configured to be worn by a user; and
one or more sensor wire bundles arranged in parallel on the frame, each comprising a plurality of sensor wires connected at one end to a control module,
wherein the control module is configured to measure electrical changes in the sensor wire bundles and further configured to indicate a direction and speed of motion of a part of the user's body past the one or more sensor wire bundles based on the measured electrical changes in the sensor wire bundles.

2. The interface device of claim 1, comprising a plurality of sensor wire bundles, wherein each sensor wire bundle comprises an indexed set of sensor wires and wherein similarly indexed sensor wires from each bundle are electrically connected to one another.

3. The interface device of claim 1, further comprising one or more sensor terminals connected to the control module, wherein the control module is configured to measure electrical changes in the sensor terminals and further configured to indicate a function activation based on a proximity of a part of the user's body to a sensor terminal based on the measured electrical changes in the sensor terminal.

4. The interface device of claim 1, further comprising a trigger terminal connected to the control module, wherein the control module is configured to apply a bias voltage to the thumb terminal that establishes a static charge at the trigger terminal.

5. The interface device of claim 4, wherein the control module measures current changes in the sensor wire bundles.

6. The interface device of claim 1, further comprising a thumb terminal including a magnet, wherein the sensor wires in the sensor wire bundles form loops connected to the control module at both ends and wherein the control module measures induced current in the loops.

7. The interface device of claim 1, wherein the control module is configured to compare the measured electrical changes to a threshold, such that the direction and speed of motion is only indicated if the electrical changes exceed the threshold.

8. The interface device of claim 1, wherein the sensor wires are electrically connected to the control module at a proximal end and are not electrically connected to anything at a distal end.

9. The interface device of claim 1,
wherein the sensor wires in the one or more sensor bundles are indexed; and
wherein the control module is configured to determine a direction and speed of motion of a part of the user's body past the one or more sensor wire bundles by determining an order and speed of electrical changes between indexed sensor wires.

10. The interface device of claim 9, wherein the control module is further configured to continue to indicate a direction and speed of motion after the user has stopped moving the body part past the one or more sensor wire bundles for a predetermined period of time.

11. An interface device, comprising:
a glove to be worn on a user's hand;
one or more finger sensors, each running along a finger of the glove and each comprising a plurality of sensor wires connected at one end to a control module; and
one or more finger terminals, each located at a fingertip of the glove, connected to the control module,
wherein the control module is configured to measure electrical changes in the sensor wire bundles, to indicate a direction and speed of motion of the user's thumb past the one or more finger sensors based on the measured electrical changes in the finger sensors, to measure electrical changes in the finger terminals, and to indicate a function activation based on a proximity of the user's thumb to a finger terminal based on the measured electrical changes in the finger terminal.

12. The interface device of claim 11, comprising a plurality of finger sensors, wherein each finger sensor comprises an indexed set of sensor wires and wherein similarly indexed sensor wires from each bundle are electrically connected to one another.

13. The interface device of claim 11, further comprising a thumb terminal located at the tip of thumb of the glove and connected to the control module, wherein the control module is configured to apply a bias voltage to the thumb terminal that establishes a static charge at the thumb terminal.

14. The interface device of claim 13, wherein the control module measures current changes in the finger sensors and finger terminals.

15. The interface device of claim 11, wherein the control module is configured to compare the measured electrical changes to a threshold, such that the direction and speed of motion is only indicated if the electrical changes exceed the threshold.

16. The interface device of claim 11, wherein the finger sensors are electrically connected to the control module at a proximal end and are not electrically connected to anything at a distal end.

17. The interface device of claim 11,
wherein the sensor wires in the one or more finger sensors are indexed; and
wherein the control module is configured to determine a direction and speed of motion of the user's thumb past the one or more finger sensors by determining an order and speed of electrical changes between indexed sensor wires.

18. A method for measuring motion, comprising:
measuring an electrical change in one or more finger sensors in a glove-based interface device triggered by a motion of a user's thumb past the one or more finger sensors;
determining an order and speed of electrical changes between indexed sensor wires in the one or more finger sensors; and
indicating a direction and speed of motion of the user's thumb based on the order and speed of electrical changes using a processor.

19. The method of claim 18, wherein determining an order and speed of electrical changes comprises comparing the measured electrical changes in said one or more finger sensors to a threshold, such that only measured electrical changes in excess of the threshold are considered.

20. The method of claim 18, further comprising:
measuring an electrical change in one or more finger terminals in the glove-based interface device triggered by proximity of a user's thumb to one of the one or more finger terminals; and
indicating a function activation based on a measured electrical change in one of the finger terminals in excess of a terminal threshold, said function activation being associated with the particular finger terminal measured.
